(19) United States
(12) Patent Application Publication
(10) Pub. No.: US 2005/0035515 A1
(43) Pub. Date: Feb. 17, 2005

(54) Tube clamp

(75) Inventors: Leonard Lee Hixon JR., Lookout Mountain, GA (US); Randy Lomar Nunley, Signal Mountain, TN (US)

Correspondence Address: PARKHURST & WENDEL, L.L.P., 1421 PRINCE STREET, SUITE 210, ALEXANDRIA, VA, 22314-2805, US

(73) Assignee: Tennessee Rand Co., Inc., Chattanooga, TN (US)

(21) Appl. No.: 10/639,763

(22) Filed: Aug. 13, 2003

(51) Int. Cl. B23Q 3/08

(52) U.S. Cl. 269/32

(57) ABSTRACT

A tube clamp having a housing with a guide slot for receiving a tube, a clamp lever arm rotatably mounted in the housing and an actuator cylinder. The actuator cylinder applies a first force against the clamp lever arm for urging a clamping surface to move against an outer surface of a tube that has been inserted in the guide slot, so as to retain the tube in a tube clamping position between a clamping surface in the guide slot and a clamping surface on the clamp lever, and upon subsequent energization, applying a second force against the clamp lever arm for urging the clamp lever arm to rotate toward a tube releasing position. The tube clamp also includes a link having end stops for engaging clamp lever arm cam surfaces, wherein reciprocal movement of the link drives the clamp lever arm in rotation between a clamp position and a release position.

### BACKGROUND OF THE INVENTION

The present invention comprises an improved tube clamp for holding tubes to be welded or otherwise processed.

### BRIEF DESCRIPTION OF THE INVENTION

The present invention comprises a mechanical tube clamp for holding a tube against a positive stop and then releasing the tube, when a pneumatic cylinder is actuated.

The present invention is a compact, fully enclosed design that provides reliable performance under severe conditions encountered in welding environments. Such design can be further enhanced by coating a steel housing of the clamp with a spatter resistant coating for resisting welding spatter. The housing also facilitates reversible mounting of the clamp tool.

### SUMMARY OF THE INVENTION

The present invention comprises a housing having a notch for receiving a tube; a clamp lever arm rotatably mounted in the housing and located for retaining a tube in the notch; and actuating means for applying a first force against the clamp lever arm for urging the clamp lever arm toward a tube retaining position for applying and a second force against the clamp lever arm for urging the clamp lever arm toward a release position.

A second embodiment of the present invention comprises a housing a housing having a guide notch for receiving a tube; a clamp lever arm rotatably mounted in the housing and including means for retaining a tube in the notch; an actuator cylinder for applying a first force against the clamp lever arm for urging the retaining means to move against a surface of a tube inserted in the notch, and for retaining a tube in the notch, and for applying a second force against the clamp lever arm for urging the clamp lever arm away from the notch toward a tube releasing position; and link means connecting the clamp lever arm and the actuator.

A third embodiment of the present invention comprises the tube clamp according to the second embodiment, wherein the clamp lever arm is pivotally mounted for rotation about a pivot, and a cam end having at least one cam surface for cooperating with a corresponding surface of the link means for rotation of the clamp lever arm about the pivot.

A fourth embodiment of the present invention comprises the tube clamp according to the third embodiment, wherein the link means further comprises end stops for engaging the clamp lever arm, wherein, upon lever movements of the link, the link drives the clamp lever arm between a clamp position and a release position.

A fifth embodiment of the present invention comprises the tube clamp according to the third embodiment, wherein the link further comprises a central hollow portion for receiving the cam end; and end stops each comprising a bushing rotatably mounted on the link for driving the clamp lever arm.

A sixth embodiment of the present invention comprises the tube clamp according to the second embodiment, wherein the tube clamp further comprises bias means located for resiliently cushioning contact between the clamp lever arm and the link means.

### BRIEF DESCRIPTION OF THE DRAWINGS

The invention is further explained in conjunction with the following figures illustrating the present invention:

FIG. 1 is a schematic view of the tube clamp of the present invention;

FIG. 2 is a plan view of the outside of the tube clamp shown in FIG. 1;

FIG. 3 is a cutaway view of FIG. 1 showing the internal components of the tube clamp;

FIG. 4 is a schematic view of the clamp lever arm shown in FIG. 3; and

FIG. 5 is a schematic side view of a typical double acting air cylinder of the tube clamp shown in FIG. 1;

FIG. 6 is a schematic view of an alternative embodiment of the bushing shown in FIG. 3.

### DESCRIPTION OF THE PREFERRED EMBODIMENTS

The subject matter of the present invention is well depicted, and described in conjunction with, the drawings herewith.

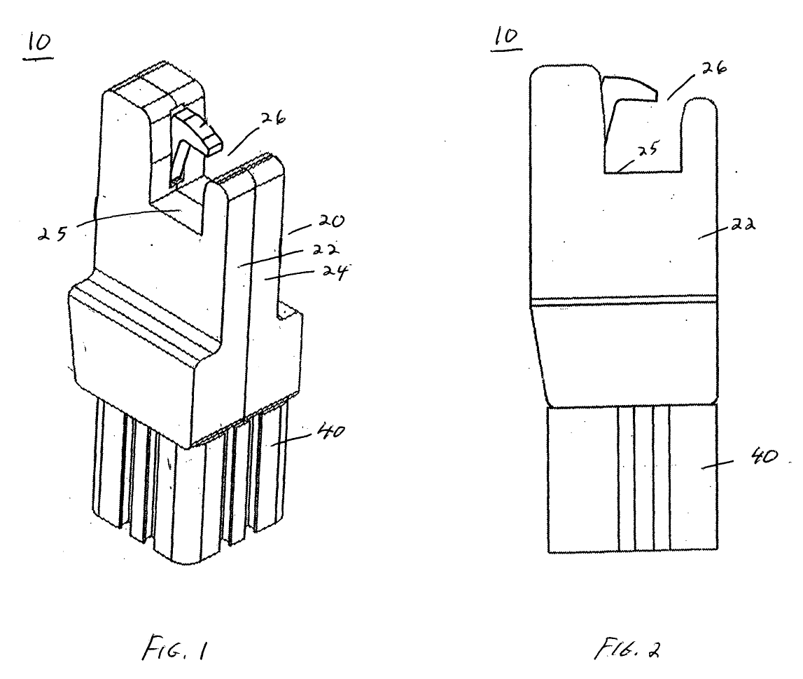

FIG. 1 shows a schematic view of the tube clamp assembly 10 of the present invention comprising a housing 20 and a pneumatic cylinder 40 attached to the housing 20. The housing 20 comprises a first side housing 22 and a second side housing 24, which together define internal compartments and a guide slot 26. The housing 20 further includes a tube clamping surface 25 located at the bottom and/or side of the guide slot 26.

FIG. 2 is a plan view of the outside of the tube clamp assembly 10, showing the outside of the first side housing 22, the guide slot 26 and the tube clamping surface 25.

FIG. 3 is a cutaway view of FIG. 1, showing the internal components of the tube clamp assembly 10. The internal working mechanism of the tube clamp assembly 10 is located in an internal compartment 30 formed between first and second side housings 22 and 24, and which houses a link 31 and a pivotable clamp lever arm 32, for cooperative movement therebetween.

FIG. 4 is an isometric view of the clamp lever arm 32, which preferably has a “C” shaped profile comprising a tube clamping end 33 and an opposite cam end 34, wherein the clamping end 33 includes a clamp lever clamping surface 33a and the cam end 34 has inner and outer cam surfaces 34a,b. The clamp lever arm 32 is rotatably attached to the housing 20 by any suitable method, and preferably has a hole 38 for receiving a bushing that is rotatably mounted to a dowel 35 fixed in the housing 20. Preferably, the clamp lever 32 is configured to close a major portion of the guide slot for the tube when it is in the clamping position.

The link 31 can take any suitable form for cooperatively engaging the clamp lever arm 32. Preferably, the link 31 is a square shaft having a central hollow portion for receiving therethrough the cam end 34 of the clamp lever arm 32. The link 31 has a dowel 36 fixed at each end thereof, each dowel 36 having a bushing 37 rotatably mounted thereon. As the link 31 reciprocates, each bushing 37 in turn contacts and drives a respective cam surface 34a,b of the clamp lever arm 32. Optionally, a bias, such as, for example, one or more springs or rubber bushings, is attached between the clamp lever arm 32 and the housing 20, or located between the clamp arm 32 and the cam surfaces 34a,b, to facilitate smooth operation. The link 31 also includes one end for receiving, and being driven by, a headed shaft of an actuator 40, which can take any suitable form, and preferably is a double acting air cylinder 40.

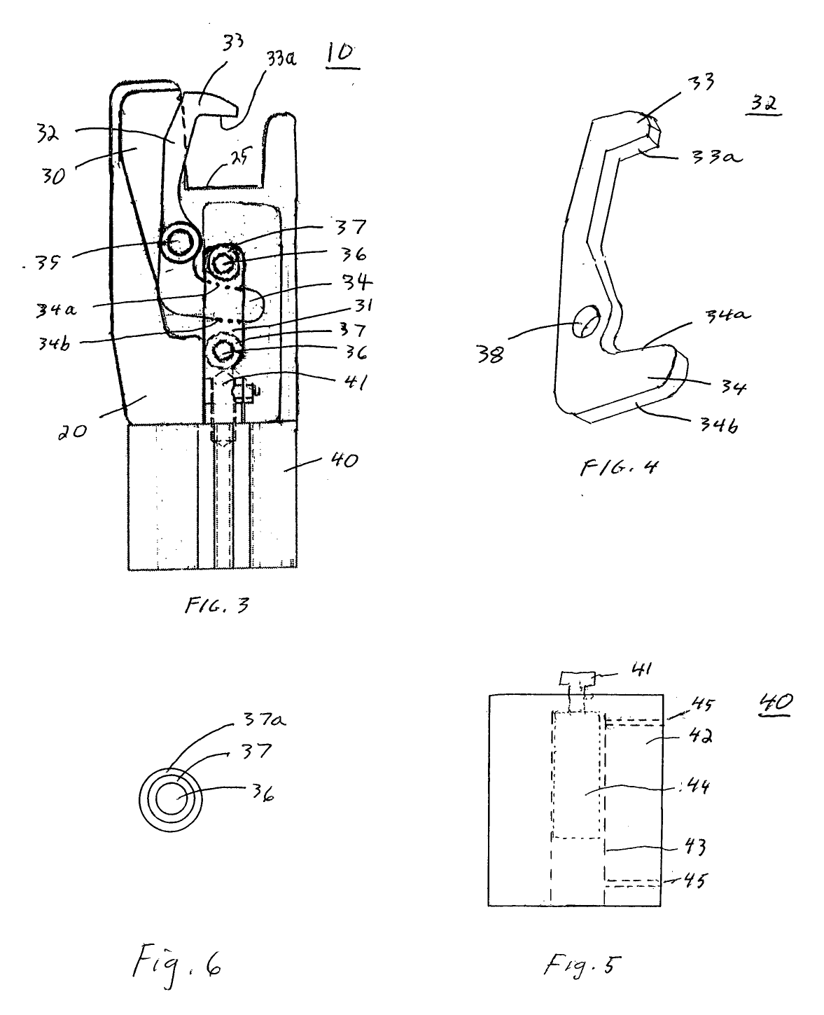

FIG. 5 is a schematic side view of a typical double acting air cylinder 40, which may be any suitable pneumatic cylinder, and therefore is not shown in detail. The double acting air cylinder 40 generally comprises a housing 42 with a bore 43 for slidably receiving a piston 44 attached to the headed shaft 41, wherein the piston 44 reciprocates in response to gas pressure from a pneumatic source (not shown) via ports 45. The air cylinder 40 is attached to the housing 20 by any suitable means, such as, for example, cap screws.

Now referring to FIG. 3, the two housings 22,24 form a guide slot 26 into which a tube can be introduced for clamping. During use, a longitudinal portion of a tube to be clamped (not shown) is pushed into the guide slot 26 so that it rests against the tube clamping surface 25. Upon energizing the double acting air cylinder 40 downwardly away from guide slot 26, the headed shaft 41 pulls the link 31 toward the air cylinder 40, thereby causing a first bushing 37 of the link 31 to contact the cam surface 34a of the clamp lever arm 32, thereby causing the clamp lever arm 32 to rotate about pivot 35, and cause the clamp lever clamping surface 33a of the clamp lever arm 32 to press against the outer surface of the tube and drive it against the tube clamping surface 25. Optionally, the clamp lever arm 32 and the tube clamping surface 25 are configured so that the tube is drawn toward, and seated against, a corner profile of the tube clamping surface 25.

Release of a tube is accomplished by again energizing the double acting air cylinder 40 so that the headed shaft 41 is driven toward the guide slot 26, thereby causing a second bushing 37 of the link 31 to contact the cam surface 34b of the clamp lever arm 32, thereby causing the clamp lever arm 32 to counter-rotate about pivot 35, and cause the clamp lever clamping surface 33a of the clamp lever arm 32 to withdraw from the surface of the tube so that the tube is free to be removed from the guide slot 26. The tube clamp assembly 10 is then ready to accept a new tube.

Optionally, bushing 37 is cushioned by biasing means 37a, taking the form of, for example, a resilient surface covering bushing 37, as shown in FIG. 6. Alternatively, biasing means 37a is a resilient bumper located between cam surfaces 34a,34b and bushing 37.

1. A tube clamp comprising:
a housing having a notch for receiving a tube;
a clamp lever arm rotatably mounted in the housing and located for retaining a tube in the notch; and
actuating means for applying a first force against the clamp lever arm for urging the clamp lever arm toward a tube retaining position, said tube retaining position for applying a second force against the clamp lever arm for urging the clamp lever arm toward a release position.

2. A tube clamp comprising:
a housing having a notch for receiving a tube;
a clamp lever arm rotatably mounted in the housing and including means for retaining a tube in the notch;
an actuator cylinder for:
applying a first force against the clamp lever arm for urging the retaining means to move against a surface of a tube inserted in said notch, and for retaining a tube in said notch, and
applying a second force against the clamp lever arm for urging the clamp lever arm away from said notch toward a tube releasing position; and
link means connecting the clamp lever arm and the actuator.

3. The tube clamp according to claim 2, wherein said clamp lever arm is pivotally mounted for rotation about a pivot, and a cam end having at least one cam surface for cooperating with a corresponding surface of the link means for rotation of said clamp lever arm about the pivot.

4. The tube clamp according to claim 3, wherein said link means further comprises end stops for engaging said clamp lever arm, wherein, upon lever movements of the link, the link drives the clamp lever arm between a clamp position and a release position.

5. The tube clamp according to claim 4, wherein said link further comprises a central hollow portion for receiving the cam end; and
end stops each comprising a bushing rotatably mounted on said link for driving said clamp lever arm.

6. The wire clamp according to claim 2, further comprising a bias means located for resiliently cushioning contact between the clamp lever arm and the link means.

7. A tube clamp comprising:
a housing having a notch for receiving a tube and a first clamping surface in said notch;
a clamp lever arm rotatably mounted in the housing and including a second clamping surface for retaining a tube against the first clamping surface, the clamp lever arm having a cam end having at least one cam surface;
a link comprising a central hollow portion for receiving the cam end and further comprising two end stops each comprising a bushing rotatably mounted on said link for engaging and driving said at least one cam surface of said clamp lever arm, wherein, movement of the link drives the clamp lever arm between a clamp position and a release position; and
an actuator cylinder connected to an end of the link, for:
applying a first force through a first of the bushings against one of the cam surfaces of said clamp lever arm for arguing the second clamping surface to move against a surface of a tube inserted in said notch, and for retaining a tube against the first clamping surface, and
applying a second force through a second of said bushings against another of the cam surfaces of said clamp lever arm for urging the clamp lever arm to move away from said notch toward a tube releasing position.
